(19) United States
(12) Patent Application Publication
(10) Pub. No.: US 2005/0214191 A1
(43) Pub. Date: Sep. 29, 2005

(54) Abrasives and compositions for chemical mechanical planarization of tungsten and titanium

(76) Inventors: Brian L. Mueller, Middletown, DE (US); Charles Yu, Wilmington, DE (US)

Correspondence Address: Rohm and Haas Electronic,;Materials CMP Holdings, Inc., Suite 1300, 1105 North Market Street, Wilmington, DE, 19899, US

(21) Appl. No.: 10/811,640

(22) Filed: Mar. 29, 2004

(51) Int. Cl. C01B 33/12

(52) U.S. Cl. 423/339; 51/308

(57) ABSTRACT

The present invention provides a method of manufacturing a fumed silica useful for polishing tungsten and titanium on a semiconductor wafer. The method comprises the act of providing a predetermined volume of water and providing a predetermined concentration of the fumed silica, wherein the concentration of the fumed silica is at least by weight percent 35 of the volume of water. Further, the invention provides the act of mixing an acid into the volume of water to acidify the water, wherein the concentration of the acid is by weight percent 0.0010 to 0.5 of the concentration of the fumed silica, and dispersing the fumed silica into the acidified water. Further, the invention provides diluting the concentration of the fumed silica, wherein the pH of the water is 1 to 7 and collecting the fumed silica.

### BACKGROUND OF THE INVENTION

The invention relates to chemical mechanical planarization or polishing (CMP) of semiconductor wafer materials and, more particularly, to CMP abrasives and methods for polishing tungsten and titanium on semiconductor wafers. Further, the present invention relates to compositions for polishing tungsten and titanium on semiconductor wafers

As the requirement for increased density of active devices on an individual chip has escalated, the requirement for greater flatness on the active surfaces of the wafer has concurrently increased. A flat surface is desired for improved interconnect metallization to underlying layers and for improved ability to fill via holes and lines.

CMP is the foremost technique to achieve the desired flatness. CMP enhances the removal of surface material, mechanically abrading the surface while a chemical composition (“slurry”) selectively attacks the surface. Accordingly, a conventional CMP slurry exhibits different removal rates (“selectivity”) for at least two different materials on the wafer surface (e.g., different polish rates for metal relative to an interlayer dielectric). Typically, a slurry contains an abrasive component to help facilitate surface removal.

Currently, CMP is the preferred method of polishing tungsten and titanium during formation of tungsten contact/via plugs. Generally, for this application, a contact/via hole is etched through a dielectric layer to expose regions of the underlying devices (for first-level metallization) or metal interconnects (for higher levels of metallization). A titanium “glue” layer is deposited onto the sides and bottom of the contact/via hole, and tungsten is deposited thereon. CMP is used to remove the deposited tungsten and titanium from the wafer surface, leaving tungsten plugs in the contact/via holes having surfaces coplanar with the exposed dielectric. Hence, a CMP slurry for tungsten processing should be highly selective for tungsten and titanium as compared to the dielectric. This selectivity allows for over-polishing while still achieving a flat tungsten plug surface.

Sethuraman et al., in U.S. Pat. No. 6,001,269, discloses a known alumina abrasive composition for polishing a semiconductor device comprising an iodate-based oxidizer. A hard, alumina abrasive is typically utilized to achieve adequate metal removal rates, especially, for metals such as titanium. Unfortunately, the alumina abrasive creates unwanted, increased defectivity. In addition, alumina abrasives tend to provide poor selectivity rates, in particular, selectivity of titanium to the oxide.

Hence, what is needed is an abrasive for chemical-mechanical polishing of tungsten and titanium having improved selectivity. In particular, what is needed is an abrasive and method that provide improved removal of the titanium layer while suppressing the removal of the dielectric layer. Further, what is needed is a composition that provides improved removal of the titanium layer while suppressing the removal of the dielectric layer having improved defectivity.

### STATEMENT OF THE INVENTION

In a first aspect, the present invention provides a method of manufacturing a fumed silica useful for polishing tungsten and titanium on a semiconductor wafer comprising: providing a predetermined volume of water; providing a predetermined concentration of the fumed silica, wherein the concentration is at least by weight percent 35 thereof, mixing an acid into the volume of water to acidify the water, wherein the concentration of the acid is by weight percent 0.0010 to 0.5 of the concentration of the fumed silica; dispersing the fumed silica into the acidified water; diluting the concentration of the fumed silica, wherein the water has a pH of 1 to 7; and collecting the fumed silica.

In a second aspect, the present invention provides a fumed silica useful for polishing tungsten and titanium on a semiconductor wafer wherein the fumed silica has a surface area of greater than 90 m²/g and has been entirely dispersed and diluted in an acidic pH.

In a third aspect, the present invention provides a composition useful for polishing tungsten and titanium on a semiconductor wafer, the composition containing an abrasive, wherein the abrasive is fumed silica that has a surface area of greater than 90 m²/g and has been entirely dispersed and diluted in an acidic pH.

### DETAILED DESCRIPTION OF THE INVENTION

The abrasive and method provide unexpected selectivity for removing tungsten and titanium relative to the dielectric layer. The abrasive is advantageously processed in an acidic pH and has a high surface area to suppress the removal of the dielectric layer. In particular, the abrasive is fumed silica that has only been processed at an acidic pH to selectively polish tungsten and titanium relative to the dielectric layer. Further, the acidic pH only processed fumed silica abrasive has a surface area greater than 90 m²/g to selectively polish tungsten and titanium relative to the dielectric layer.

As used herein, an “acidic pH only processed abrasive,” “acidic pH only processed fumed silica,” “acidic abrasive,” and “acidic fumed silica,” are defined as an abrasive that has only been processed at an acidic pH. In other words, the abrasive was not dispersed or diluted in a basic solution at any point, including, the final formulation.

Advantageously, the acidic fumed silica of the present invention is fabricated by initially filling a mixer with a predetermined volume of de-ionized water. Preferably, the mixer utilized is a high shear mixer, for example, a Myers Mixer manufactured by Meyers Engineering, Inc. of Bell, Calif. Fumed silica, for example, Aerosil 130 (“A 130”) is commercially available from Degussa, of Parsippany, N.J. Thereafter, a predetermined amount of acid is added to the water based upon the desired pH. After the addition of acid to the water, the mixer operates to mix the acid and water to form an acidic water solution. The acid may be a mineral or organic acid such as hydrochloric acid, sulfuric acid, nitric acid, phosphoric acid, acetic acid or maleic acid. Preferably, the acid is hydrochloric acid.

Advantageously, the quantity of acid added to the water is an amount, by weight percent, between 0.0010 and 0.50 of fumed silica that will be added to the water. Preferably, the quantity of acid added to the water is an amount, by weight percent, between 0.0015 and 0.15 of fumed silica that will be added to the water.

The initial quantity of water chosen is based on the amount of fumed silica to be added, and the desired final concentration of fumed silica in the aqueous dispersion. For example, if the desired final concentration of the aqueous dispersion of fumed silica is by weight percent 35 fumed silica, then the initial quantity of water is that quantity or concentration that will result in a greater than 35 weight percent fumed silica in the mixer. In the present invention, the dispersion will have a fumed silica concentration about 5 weight percent greater than the desired final concentration of fumed silica in the aqueous dispersion of fumed silica. Thereafter, the aqueous dispersion in the mixer will be diluted by the addition of an additional amount of water to achieve the desired final concentration of fumed silica.

Next, fumed silica is dispersed in the water-acid solution in the mixer to a predetermined concentration. Advantageously, the temperature of the solution is maintained at less than 60° C., preferably, less than 35° C. The fumed silica may be added by mixing the fumed silica into the water-acid mixture while the mixer is operating, or by adding the fumed silica to the water-acid mixture and then operating the mixer. The fumed silica may also be added incrementally, in a series of steps, with the mixer operating between each step. After the concentration of fumed silica in the aqueous dispersion has been raised to a point above the desired final concentration of fumed silica, the mixer is allowed to operate until the dispersion in the mixer reaches a desired viscosity. The high shear mixing breaks down the agglomerated structure of the dry fumed silica causing the viscosity to drop. Hence, the high shear mixing is maintained throughout the process to cause deagglomeration. If the mixer stops, the dispersion may gel and lock up the mixer and result in unwanted, larger particles in the dispersion. As discussed, the dispersion in the mixer, before dilution, will have a fumed silica concentration about 5 percent greater than the desired final concentration of fumed silica.

Advantageously, the aqueous dispersion contains, by weight percent, at least 35 fumed silica. Preferably, the aqueous dispersion contains, by weight percent, between 40 to 65 fumed silica. In addition, the fumed silica advantageously has a surface area greater than 90 m²/g. Preferably, the fumed silica advantageously has a surface area greater than 130 m²/g.

Next, the dispersion is diluted by the addition of de-ionized water. The additional water is then mixed into the aqueous dispersion in the mixer. The amount of water added is an amount sufficient to lower the concentration of fumed silica in the aqueous dispersion to the desired final concentration. Note, the pH of the solution during dilution is maintained, at all times, between 1 to 7. Preferably, the pH of the solution is 1.5 to 5.5.

Thereafter, the aqueous dispersion of fumed silica may be centrifuged or decanted, as desired. In addition, the aqueous dispersion of fumed silica may be passed through a filter to remove grit and any agglomerated fumed silica particles. In particular, any unwanted particles having a diameter greater than 1 micrometer is filtered. Thereafter, the filtered fumed silica may be packaged, as desired, for future use.

The method of the present invention allows the production of fumed silica useful in polishing tungsten and titanium in semiconductor wafers. In particular, the method provides an acidic aqueous dispersion having a fumed silica concentration of at least 35 weight percent. More preferably, the aqueous dispersion has a fumed silica concentration between 40 and 65 weight percent. The quantity of acid added to the water is an amount, by weight percent, between 0.0010 and 0.50 of fumed silica that will be added to the water. The pH of the solution during dilution is maintained, at all times, between 1 to 7. Preferably, the pH is 1.5 to 5.5. In addition, the fumed silica advantageously has a surface area greater than 90 m²/g. Preferably, the fumed silica advantageously has a surface area greater than 130 m²/g.

The acidic abrasive of the present invention is advantageously utilized in a composition useful for polishing tungsten and titanium on a semiconductor wafer. In addition to the acidic abrasive, the composition may advantageously contain 0.5 to 9 weight percent oxidizer. Preferably, the oxidizer is in the range of 1 to 4 weight percent. Most preferably, the oxidizer is in the range of 2.5 to 3.5 weight percent. The oxidizing agent can be at least one of a number of oxidizing compounds, such as hydrogen peroxide (H₂O₂), monopersulfates, iodates, magnesium perphthalate, peracetic acid and other per-acids, persulfates, bromates, periodates, nitrates, iron salts, cerium salts, Mn (III), Mn (IV) and Mn (VI) salts, silver salts, copper salts, chromium salts, cobalt salts, halogens hypochlorites and a mixture thereof. Furthermore, it is often advantageous to use a mixture of oxidizer compounds. When the polishing slurry contains an unstable oxidizing agent such as, hydrogen peroxide, it is often most advantageous to mix the oxidizer into the slurry at the point of use. The preferred oxidizing agent is an iodate, including, its acids, salts, mixed acid salts, esters, partial esters, mixed esters, and mixtures thereof.

Advantageously, the solution may contain 0.1 to 5 weight percent complexing agent to soften the passivating layer on tungsten. Preferably, the complexing agent is in the range of 0.5 to 3 weight percent. Most preferably, the complexing agent is in the range of 1 to 2 weight percent. Advantageously, the solution contains a “phosphorus-containing” compound as a complexing agent. A “phosphorus-containing” compound is any compound containing a phosphorus atom. A preferred phosphorus-containing compound is, for example, a phosphate, pyrophosphate, metaphosphate, hypophosphate, polyphosphate, phosphonate, including, their acids, salts, mixed acid salts, esters, partial esters, mixed esters, and mixtures thereof. In particular, a preferred aqueous polishing composition can be formulated using, for example, the following phosphorus-containing compounds: zinc phosphate, zinc pyrophosphate, zinc metaphosphate, zinc hypophosphate, zinc polyphosphate, zinc phosphonate, ammonium phosphate, ammonium pyrophosphate, ammonium metaphosphate, ammonium hypophosphate, ammonium polyphosphate, ammonium phosphonate, diammonium phosphate, diammonium pyrophosphate, diammonium metaphosphate, diammonium hypophosphate, diammonium polyphosphate, diammonium phosphonate, guanidine phosphate, guanidine pyrophosphate, guanidine metaphosphate, guanidine hypophosphate, guanidine polyphosphate, guanidine phosphonate, iron phosphate, iron pyrophosphate, iron metaphosphate, iron hypophosphate, iron polyphosphate, iron phosphonate, cerium phosphate, cerium pyrophosphate, cerium metaphosphate, cerium hypophosphate, cerium polyphosphate, cerium phosphonate, ethylene-diamine phosphate, piperazine phosphate, piperazine pyrophosphate, piperazine metaphosphate, piperazine hypophosphate, piperazine phosphonate, melamine phosphate, dimelamine phosphate, melamine pyrophosphate, melamine metaphosphate, melamine hypophosphate, melamine polyphosphate, melamine phosphonate, melam phosphate, melam pyrophosphate, melam metaphosphate, melam hypophosphate, melam polyphosphate, melam phosphonate, melem phosphate, melem pyrophosphate, melem metaphosphate, melem hypophosphate, melem polyphosphate, melem phosphonate, potassium phosphate, potassium pyrophosphate, potassium metaphosphate, potassium hypophosphate, potassium polyphosphate, potassium phosphonate, dicyanodiamide phosphate, urea phosphate, including, their acids, salts, mixed acid salts, esters, partial esters, mixed esters, and mixtures thereof. Also, phosphine oxides, phosphine sulphides and phosphorinanes of phosphonates, phosphites and phosphinates may be used, including, their acids, salts, mixed acid salts, esters, partial esters and mixed esters. A preferred phosphorus-containing compound is potassium pyrophosphate.

In addition to the complexing agent, the composition may advantageously contain 0.1 to 5 weight percent of a chelating agent to minimize tungsten oxide polishing debris from building up on the pad. Preferably, the composition contains 0.5 to 3 weight percent of a chelating agent. Most preferably, the composition contains 1 to 2 weight percent of a chelating agent. Example chelating agents are carboxylic acids, including, their metal and non-metal salts. The chelating agent can have mono-, di-, tri-, or poly carboxylic groups attached to an open chain alkane (or its derivative) structure, or bonded to a ring structure. Examples of carboxylic acids include acetic acid, propionic acid, butyric acid, pivalic acid, oxalic acid, malonic acid, succinic acid, glutaric acid, adipic acid, benzoic acid, succinic acid, aspartic acid, gallic acid, gluconic acid, tannic acid and phthalic acid, and mixtures thereof. Preferred chelating agent is a α-hydroxy carboxylic acid (AHA), including, their metal and non-metal salts. An AHA is an organic acid containing a hydroxyl group on the carbon atom immediately adjacent to a carboxylic group. Examples of AHA include glycolic acid, lactic acid, tartaric acid, citric acid, malic acid, mandelic acid and salicylic acid, and mixtures thereof. A preferred AHA is lactic acid.

The compounds provide efficacy over a broad pH range in solutions containing a balance of water. This solution's useful pH range extends from at least 1 to 7. In addition, the solution advantageously relies upon a balance of deionized water to limit incidental impurities. The pH of the polishing fluid of this invention is preferably from 2 to 5, more preferably a pH of 3.5 to 4.5. The acids used to adjust the pH of the composition of this invention are, for example, nitric acid, sulfuric acid, hydrochloric acid, phosphoric acid and the like.

Optionally, the solution may contain by weight percent, 0.1 to 5 an additive to suppress the removal of the oxide. Preferably, the solution contains by weight percent, 0.5 to 3 of the oxide suppressant. Most preferably, the solution contains by weight percent, 1 to 2 of the oxide suppressant. Example additives include, ethylenediaminetetracetic acid and salts thereof, ethylene diamine, 1,4-diazabicyclo octane, ethylene glycol, crown ethers, catechol and gallol, citric acid, lactic acid, malonic acid, tartaric acid, succinic acid, malic acid, acetic acid and oxalic acid, amino acids, sulfamic acid, amino sulfuric acids, phosphoric acids, phosphonic acids, 2-quinoline carboxylic acid, and their salts. Further, example additives include, fluoride, flouboric acid, fluotitanic acid, hydrofluoric acid, fluosilicic acid, and their salts. In addition, polymeric additives such as polyacrylic acid, propylene oxide, polypyrilidone, polyethylene oxide and polyvinylalcohol may also be used.

Accordingly, the present invention provides a method of manufacturing a fumed silica useful for polishing tungsten and titanium on a semiconductor wafer. The method comprises the act of providing a predetermined volume of water and providing a predetermined concentration of the fumed silica, wherein the concentration of the fumed silica is at least by weight percent 35 of the volume of water. Further, the invention provides the act of mixing an acid into the volume of water to acidify the water, wherein the concentration of the acid is by weight percent 0.0010 to 0.5 of the concentration of the fumed silica, and dispersing the fumed silica into the acidified water. Further, the invention provides diluting the concentration of the fumed silica, wherein the pH of the water is 1 to 7 and collecting the fumed silica. Note, the fumed silica of the present invention is pure silica. In other words, the fumed silica does not contain trace amounts of, for example, metal ions or polymers to impart charge to the silica at the acidic pH.

### EXAMPLES

In the Examples, numerals represent examples of the invention and letters represent comparative examples. All example solutions contained, by weight percent, 3 potassium iodate, 1.5 potassium pyrophosphate and 1.5 lactic acid.

### Example 1

This experiment measured the selectivity of tungsten and titanium relative to TEOS on a semiconductor wafer. In particular, the effect of fumed silica that has only been processed at an acidic pH, on selectivity of tungsten and titanium relative to TEOS was tested. In other words, the fumed silica abrasive of Test 1 was not dispersed or diluted in a basic solution at any point during the preparation process. In particular, the fumed abrasive was prepared by the following method: 1) A jacket mixing vessel was initially charged with 6531 grams of de-ionized water and 6.8 grams of hydrochloric acid. The pH was maintain at 2. Cooling was turned on and the temperature in the vessel was controlled to be below 35° C. The mixer was started and brought up to operate at 6158 rpm. The mixer was a Myers Mixer manufactured by Meyers Engineering, Inc. of Bell, Calif.; 2) The fumed silicon dioxide (A 130) was metered in slowly to allow for viscosity breakdown and to prevent high current draw on the motor. Total charge of silica was 4540 grams. De-ionized water (272 g) was used to spray down sides of container to knock down silica powder. Total charge at this point is 11350 grams with silica concentration at 40% solids; 3) The mixer was then run for 60 minutes, maintaining temperature below 35° C.; 4) A secondary vessel was charge with sufficient de-ionized water to bring solids down to 20% and an impellor mixer was started. The dispersion from the jacketed tank was rapidly added to the secondary vessel; 5) The pH, % solids and particle size were tested and prepared for use.

The solutions of Example 1 contained 3 weight percent fumed silica abrasive having a surface area of 130 m²/g. An IPEC 472 DE 200 mm polishing machine using an IC1000™ polyurethane polishing pad (Rohm and Haas Electronic Materials CMP Technologies) under downforce conditions of about 5 psi, a polishing solution flow rate of 150 cc/min, a platen speed of 65 RPM and a carrier speed of 65 RPM planarized the samples. The polishing solutions had a pH of 4.0 adjusted with nitric acid. All solutions contained deionized water.

TABLE 1

| | Abrasive | | | | | |
|---|---|---|---|---|---|---|
| | processed | | | | | |
| | entirely in an | TEOS | W | Ti | Selectivity | Selectivity |
| Test | acidic pH? | (Å/min) | (Å/min) | (Å/min) | (W/TEOS) | (Ti/TEOS) |
| A | No | 273 | 2023 | 4190 | 7.41 | 15.35 |
| 1 | Yes | 79 | 2340 | 4328 | 29.62 | 54.78 |

As illustrated in Table 1 above, the addition of acidic abrasive improved the selectivity of the composition. In particular, the addition of the acidic fumed silica improved the selectivity of the composition of Test 1 for tungsten relative to the TEOS to 29.62 from 7.41 in comparative Test A. Similarly, the addition of the acidic fumed silica improved the selectivity of the composition of Test 1 for titanium relative to the TEOS to 54.78 from 15.35 in comparative Test A. The addition of the acidic fumed silica effectively suppressed the removal of TEOS from 273 Å/min to 79 Å/min in Test A to Test 1, respectively.

### Example 2

This experiment measured the selectivity of tungsten and titanium relative to TEOS on a semiconductor wafer. In particular, the effect of the surface area of fumed silica that has been processed entirely in an acidic pH, on selectivity of tungsten and titanium relative to TEOS, was tested. In other words, the fumed silica abrasive of Example 2 was not dispersed or diluted in a basic solution at any point during the preparation process. The solutions of Example 2 contained 3 weight percent fumed silica abrasive. All other test conditions were the same as those of Example 1.

TABLE 2

| | Surface Area | | | | | |
|---|---|---|---|---|---|---|
| | of Abrasive | TEOS | W | Ti | Selectivity | Selectivity |
| Test | (m²/g) | (Å/min) | (Å/min) | (Å/min) | (W/TEOS) | (Ti/TEOS) |
| B | 90 | 610 | 2072 | 4497 | 3.40 | 7.37 |
| 2 | 130 | 86 | 1989 | 4230 | 23.26 | 49.19 |
| 3 | 200 | 47 | 2442 | 4509 | 51.95 | 95.94 |

As illustrated in Table 2 above, the surface area of the acidic pH only treated abrasive effects the selectivity of the composition. In particular, the addition of the acidic fumed silica having a surface area of greater than 90 m²/g improved the selectivity of the compositions for tungsten and titanium relative to the TEOS. For example, Test 2 provided an increased selectivity of 23.26 and 49.19 for tungsten and titanium, respectively, from 3.40 and 7.37 for tungsten and titanium, respectively, in comparative Test B, when the surface area was increased from 90 m²/g to 130 m²/g. Also, the increased surface area from 90 m²/g to 130 m²/g in Test B to Test 2 suppressed the TEOS removal rate from 610 Å/min to 86 Å/min. Further, the increased surface area from 90 m²/g to 200 m²/g in Test B to Test 3 suppressed the TEOS removal rate from 610 Å/min to 47 Å/min, respectively. Tests 2 and 3 provided excellent removal of titanium.

Accordingly, the present invention provides a method of manufacturing a fumed silica useful for polishing tungsten and titanium on a semiconductor wafer. The method comprises the act of providing a predetermined volume of water and providing a predetermined concentration of the fumed silica, wherein the concentration of the fumed silica is at least by weight percent 35 of the volume of water. Further, the invention provides the act of mixing an acid into the volume of water to acidify the water, wherein the concentration of the acid is by weight percent 0.0010 to 0.5 of the concentration of the fumed silica, and dispersing the filmed silica into the acidified water. Further, the invention provides diluting the concentration of the fumed silica, wherein the pH of the water is 1 to 7 and collecting the fumed silica.

1. A method of manufacturing a fumed silica useful for polishing tungsten and titanium on a semiconductor wafer comprising:
providing a predetermined volume of water;
providing a predetermined concentration of the fumed silica, wherein the concentration is at least by weight percent 35 of the volume of water;
mixing an acid into the volume of water to acidify the water, wherein the concentration of the acid is by weight percent 0.0010 to 0.5 of the concentration of the fumed silica;
dispersing the fumed silica into the acidified water;
diluting the concentration of the fumed silica, wherein the water has a pH of 1 to 7; and
collecting the fumed silica.

2. The method of claim 1 wherein the pH of the water is 1.5 to 5.5.

3. The method of claim 1 wherein the dispersing is performed at a temperature less than 60° C.

4. The method of claim 1 wherein the concentration of the fumed silica is by weight percent between 40 to 60 of the volume of water.

5. The method of claim 1 wherein the concentration of the acid is by weight percent 0.02 to 0.15 of the concentration of the fumed silica.

6. The method of claim 1 wherein the fumed silica has a surface area of greater than 90 m²/g.

7. The method of claim 6 wherein the fumed silica has a surface area of greater than 130 m²/g.

8. A fumed silica useful for polishing tungsten and titanium on a semiconductor wafer wherein the fumed silica has a surface area of greater than 90 m²/g and has been entirely dispersed and diluted in an acidic pH.

9. The fumed silica of claim 8 wherein the fumed silica has a surface area greater than 130 m²/g.

10. A composition useful for polishing tungsten and titanium on a semiconductor wafer, the composition containing an abrasive, wherein the abrasive is fumed silica that has a surface area of greater than 90 m²/g and has been entirely dispersed and diluted in an acidic pH.
